(19) United States
(12) Patent Application Publication
(10) Pub. No.: US 2008/0158127 A1
(43) Pub. Date: Jul. 3, 2008

(54) Liquid crystal display panel having repair line

(75) Inventors: Shing-Shiang Chang, Miao-Li (TW); Sheng-Pi Yang, Miao-Li (TW)

Correspondence Address: WEI TE CHUNG;FOXCONN INTERNATIONAL, INC., 1650 MEMOREX DRIVE, SANTA CLARA, CA, 95050, US

(73) Assignee: INNOLUX DISPLAY CORP.

(21) Appl. No.: 12/005,942

(22) Filed: Dec. 29, 2007

(30) Foreign Application Priority Data
Dec. 29, 2006 (TW) 95149724

(51) Int. Cl. G09G 3/36

(52) U.S. Cl. 345/93

(57) ABSTRACT

An exemplary liquid crystal panel (2) includes a data driver (220), a gate driver (210), a plurality of data lines (203) arranged in parallel and spaced from each other, a plurality of gate lines (201) arranged in parallel and spaced from each other, a plurality of data connecting lines (204), a plurality of gate connecting lines (207), and a repair line. The first pads are connected to the data lines via the data connecting lines. The second pads being connected to the gate lines via the gate connecting lines. The repair line includes a first sub repair line (2081), a second sub repair line (2082), and a third sub repair line (2083). The first sub repair line intersects with the data connecting lines, the second sub repair line intersects with the first pads, and the third sub repair line electrically connects the first and second sub repair lines.

### FIELD OF THE INVENTION

The present invention relates a liquid crystal panel having a repair line configured for repairing an opening of a connecting line.

### GENERAL BACKGROUND

A liquid crystal display (LCD) has the advantages of portability, low power consumption, and low radiation, and has been widely used in various portable information products such as notebooks, personal digital assistants (PDAs), video cameras and the like. Furthermore, the LCD is considered by many to have the potential to completely replace CRT (cathode ray tube) monitors and televisions. A typical LCD usually includes a liquid crystal panel configured for displaying image.

A typical liquid crystal panel includes a plurality of pixel areas defined by the gate lines and the data lines. During a fabrication process of the liquid crystal panel, the data lines are prone to break when the surface of the liquid crystal display is uneven, or when the liquid crystal panel is heated or etched. Therefore, a method for repairing the broken data lines is adopted.

Referring to FIG. 6, a typical liquid crystal panel 1 includes a first substrate 10, a second substrate 11 opposite to the first substrate 10. The second substrate 11 includes a plurality of gate lines 101 arranged in parallel, a plurality of data lines 103 arranged in parallel and perpendicular to the gate lines 101, a plurality of common electrode 102 parallel to the gate lines 101, a gate driver 110 and a data driver 120. The gate driver 110 is configured for providing scanning signals to the gate lines.

The data drivers 120 includes a plurality pads 121. Each of the data lines 103 is connected to the corresponding pad 121 via a data connecting line 104. The data driver 120 is configured for providing data signals to the data lines 103 via the connecting lines 104.

The gate lines 101 and the data lines 103 define a plurality of pixel areas (not labeled). The common electrode 102 goes across a whole row of pixel areas. The common electrode 102 includes a plurality of first electrodes 105 corresponding to the pixel areas. The first electrodes 105 are perpendicular to the common electrode 102. Each of the first electrodes 105 includes two second electrodes 106 arranged perpendicularly to the first electrode 105. The second electrodes 106 each intersect with the data lines 103 and are insulated from the corresponding data lines 103.

Referring to FIG. 7, the data line has a broken gap in the pixel area. The corresponding second electrodes 106 can be electrically connected to the data line 103 and the corresponding first electrode 105 can be detached from the common electrode 102 by a process of welding. In this case, the data line 103 is repaired, and the data signal is transmitted through the electrically connecting second electrodes 106 and first electrode 105.

In general, the second substrate 11 has a slightly greater size than the first substrate 10 in order to exposing part of the data connecting lines 104 after a process of sealing the first and second substrates 10, 11 together with sealant material. Then, the exposing data connecting lines 104 are connected to the corresponding data drivers 120.

However, during the process of sealing, the first and second substrates 10, 11 are part of two big glass substrates opposite to each other. After the process of sealing, a process of cutting is needed for separating the substrates 10, 11 from the glass substrates respectively. During the process of cutting, lots of glass fibers are generated. If the glass fibers are not cleared, the glass fibers can damage the data connecting lines 104 and cause the data connecting lines 104 having broken gaps. In addition, the sealant usually has particles inside. The particles can also cause broken gaps of the data connecting lines 104. Therefore, the data connecting lines 104 may have broken gaps, and the performance of liquid crystal panel 1 having the damaged data connecting lines 104 is impaired.

What is needed, therefore, is a liquid crystal panel that can overcome the above-described deficiencies.

### SUMMARY

An exemplary liquid crystal panel includes a data driver, a gate driver, a plurality of data lines arranged in parallel and spaced from each other, a plurality of gate lines arranged in parallel and spaced from each other, a plurality of data connecting lines, a plurality of gate connecting lines, and a repair line. The first pads are connected to the data lines via the data connecting lines. The second pads being connected to the gate lines via the gate connecting lines. The repair line includes a first sub repair line, a second sub repair line, and a third sub repair line. The first sub repair line intersects with the data connecting lines, the second sub repair line intersects with the first pads, and the third sub repair line electrically connects the first and second sub repair lines.

Other novel features and advantages will become more apparent from the following detailed description when taken in conjunction with the accompanying drawings.

### BRIEF DESCRIPTION OF THE DRAWINGS

FIG. 1 is a top plan view showing an abbreviated circuitry diagram of a liquid crystal panel according to a first embodiment of the present invention, the liquid crystal panel including a plurality of data lines and data connecting lines.

FIG. 2 is an abbreviated, schematic view showing a repairing procedure of the data line and the data connecting line of FIG. 1.

FIG. 3 is a top plan view showing an abbreviated circuitry diagram of a liquid crystal panel according to a second embodiment of the present invention.

FIG. 4 is a top plan view showing an abbreviated circuitry diagram of a liquid crystal panel according to a third embodiment of the present invention.

FIG. 5 is a top plan view showing an abbreviated circuitry diagram of a liquid crystal panel according to a fourth embodiment of the present invention.

FIG. 6 is a top plan view showing an abbreviated circuitry diagram of a conventional liquid crystal panel, the conventional liquid crystal panel including a plurality of data lines.

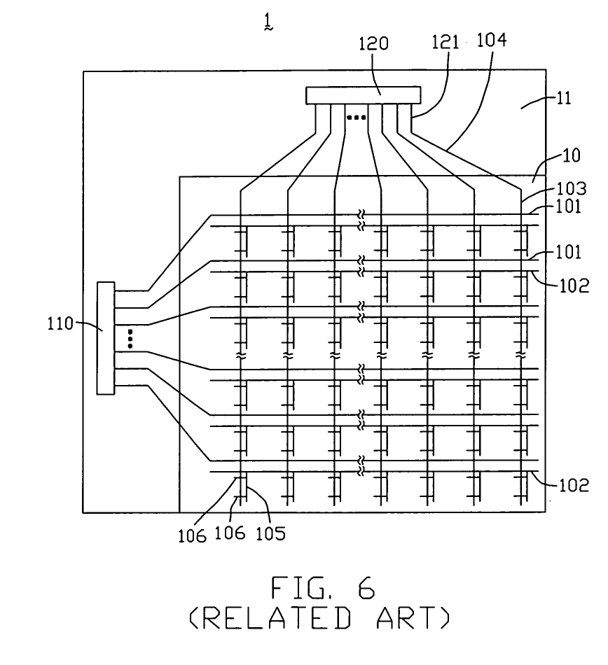

FIG. 7 is an abbreviated, schematic view showing a repairing procedure of the data line of FIG. 6.

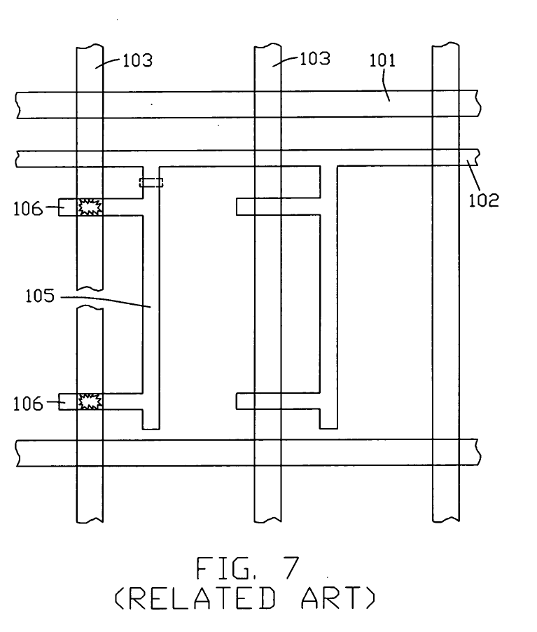

### DETAILED DESCRIPTION OF PREFERRED EMBODIMENTS

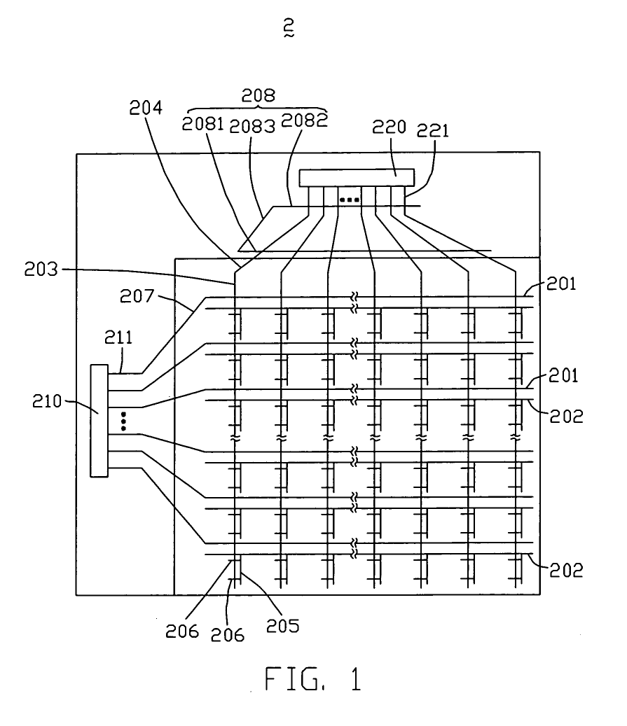

Referring to FIG. 1, an abbreviated circuitry diagram of a liquid crystal panel 2 according to a first embodiment of the present invention is shown. The liquid crystal panel 2 includes a plurality of gate lines 201 arranged in parallel with a predetermined space to each other, and a plurality of data lines 203 arranged in parallel with a predetermined space to each other and perpendicular to the gate lines 201, a plurality of common electrodes 202 parallel to the gate lines 201, a plurality of repair lines 208, a gate driver 210, and a data driver 220.

The data driver 220 includes a plurality of first pads 221. The data lines 203 each are connected to the first pads 221 via a plurality of data connecting lines 204 respectively. The data driver 220 is configured for providing a plurality of data signals to the data lines 203.

The gate driver 210 includes a plurality of second pads 211. Each of the gate lines 201 is connected to the second pad 211 via one gate connecting line 207. The gate driver 210 is configured for providing a plurality of scanning signals to the gate lines 201.

The repair line 208 is disposed between the data drivers 220 and the data lines 203, corresponding to the data line . The repair line 208 includes a first sub repair line 2081, a second sub repair line 2082, and a third sub repair line 2083. The first sub repair line 2081 intersects with the data connecting lines 204 and is insulated from the data connecting lines 204. The second sub repair line 2082 intersects with the first pads 221 and is insulated from the first pads 221. One end of the third sub repair line 2083 is connected to the first sub repair line 2081, and the other end of the third sub repair line 2083 is connected to the second sub repair line 2082. The first sub repair line 2081 intersects with end portions of the data connecting lines 204 which are adjacent to the data lines 203.

A minimum area constituted by two adjacent gate lines 201 and two adjacent data lines 203 is defined as a pixel area (not labeled). Each of the common electrode 202 traverses across a whole row of pixel areas. The common electrode 202 includes a plurality of first portions 205 each corresponding to a pixel area. The first portions 205 extend perpendicularly from the common electrode 202. Each first portion 205 includes two second portions 206 generally extending perpendicularly from the first portion with a predetermined distance to each other. The second portions 206 intersect with the data lines 203 and are insulated from the data lines 203. The two second portions 206 are substantially adjacent to the common electrode 202 and the corresponding gate line 201 such that the broken gap is located between the two second portions 206.

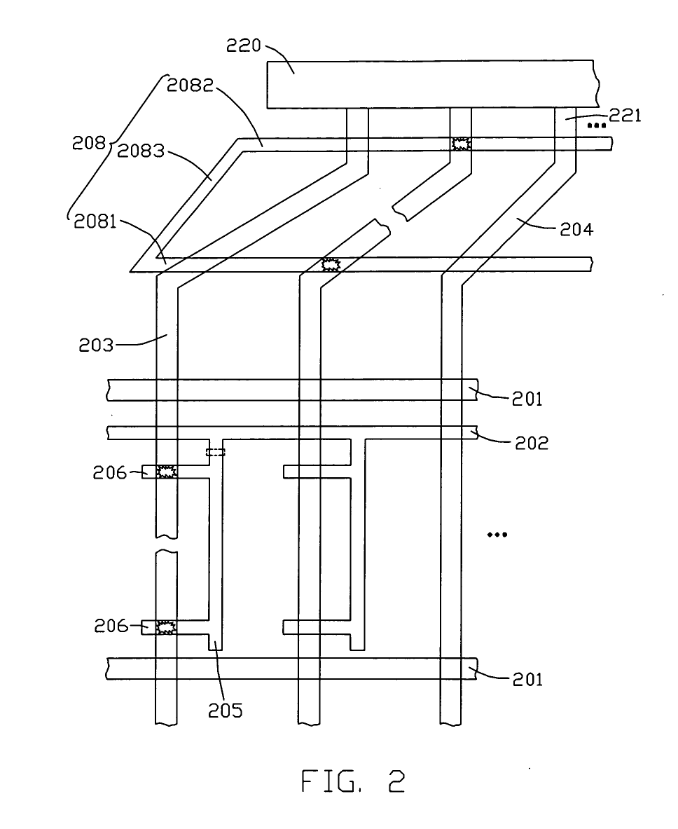

Referring to FIG. 2, this is an abbreviated, schematic view showing a repairing procedure of the data line 203 and the data connecting line 204. When one of the data lines 203 has a broken gap (not labeled) located between two corresponding second portions 206. The second portions 206 are electrically connected to the corresponding data line 203 by a process of welding. The first portion 205 corresponding to the two second portions 206 is detached from a main portion of the common electrode 202 by a process of welding. Thus, the data line 203 is repaired, and the data signal is transmitted through the electrically connecting second portions 206 and first portion 205 electrically connected thereof.

When one of the data connecting lines 204 has a broken gap (not labeled), the first sub repair line 2081 and the second sub repair line 2082 are electrically connected to the data connecting line 204 that has the broken gap by a process of welding. Thus, the data signal applied to the broken data connecting line 204 is transmitted to the corresponding data line 203 via the second sub repair line 2082, the third sub repair line 2083, and the first sub repair line 2081 sequentially. In this case, the broken data connecting line 204 is repaired and the performance of the liquid crystal panel 2 is good.

Because the repair line 208 includes the first sub repair line 2081 intersecting with end portions of the data connecting line, the second sub repair line 2082 intersecting with the first pads 221, and the third sub repair line 2083 connecting the first and second sub repair lines 2081, 2082, the broken data connecting line 204 can be repaired by a process of welding the repair line 208 and the broken data connecting line 204 together. The welding process usually is a laser welding process. In general, an insulating layer is pre-provided for insulating the first sub repair line 2081 and the data connecting lines 204 and the second sub repair line 2082 and the first pads 221. In the welding process, the insulating layer corresponding to a point of intersection of the first sub repair line 2081 and the broken data connecting line 204 is removed, and the first sub repair line 2081 is electrically connected to the corresponding data connecting lines 204. The insulating layer corresponding to a point of intersection of the second sub repair line 2082 and the corresponding first pad 221 is removed, and the second sub repair line 2082 is electrically connected to the first pad 221 that is connected to the broken data connecting line 204. Thus, the data connecting line 204 having broken gap is repaired.

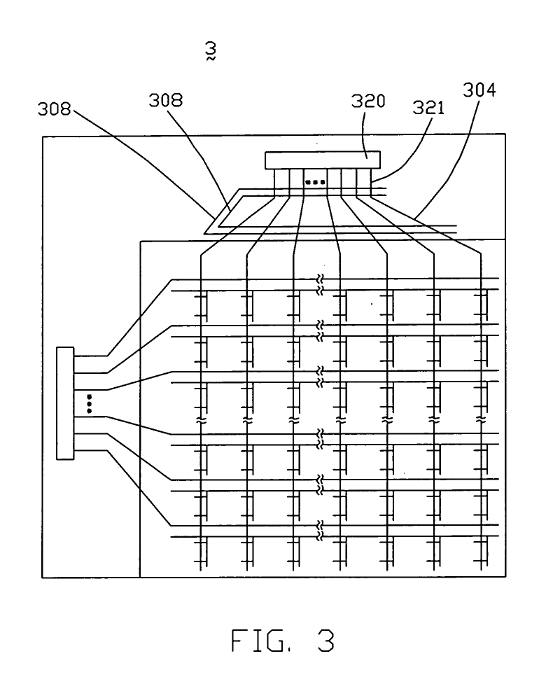

Referring to FIG. 3, an abbreviated circuitry diagram of a liquid crystal panel 3 according to a second embodiment of the present invention is shown. The liquid crystal panel 3 is similar to the liquid crystal panel 2. However, the liquid crystal panel 3 includes two repair lines 308, a data driver 320, and a plurality of data connecting lines 304. The data driver 320 includes a plurality of pads 321 connected to the data connecting lines 304 respectively. The data connecting lines 304 are connected to a plurality of data lines (not labeled). Each of the repair lines 308 includes a first sub repair line (not labeled) intersecting with the pads 321, a second sub repair line (not labeled) intersecting with end portions of the data connecting lines 304 and is adjacent to the data lines, and a third sub repair line (not labeled) connecting the first and second sub repair lines. The repair lines 308 are insulated from each other, and each of the repair lines 308 is insulated from the pads 321 and the data connecting lines 304 respectively. The first sub repair lines are generally parallel. The second sub repair lines are generally parallel. The third sub repair lines are generally parallel. In the illustrated embodiment, the two repair line 308 are configured for different repairing data connecting lines 304 respectively. That is, if there are two data connecting lines 304 having broken gaps respectively, the repair lines 308 can repair the date connecting lines 304 having broken gaps respectively.

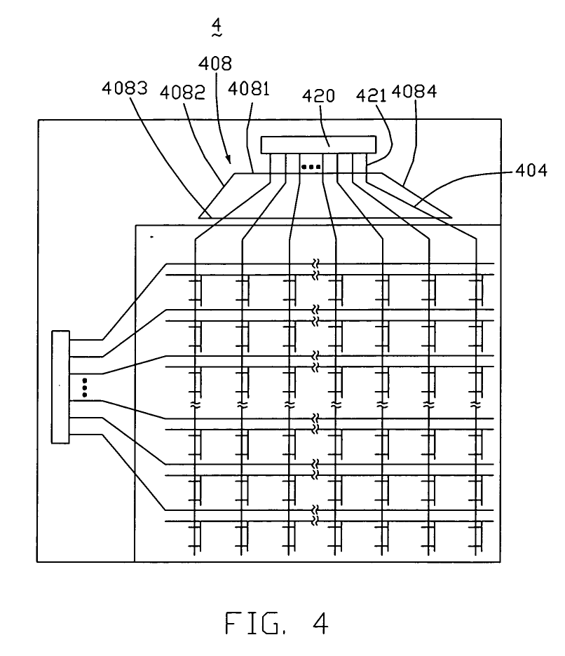

Referring to FIG. 4, an abbreviated circuitry diagram of a liquid crystal panel 4 according to a third embodiment of the present invention is shown. The liquid crystal panel 4 is similar to the liquid crystal panel 2. However, the liquid crystal panel 4 includes an annular-type (close-type) repair line 408. The repair line 408 includes a first sub repair line 4081, a second sub repair line 4082, a third sub repair line 4083, and a fourth sub repair line 4084 connected end to end. The first sub repair line 4081 intersects with and is insulated from a plurality of pads 421 of a data driver 420. The third sub repair line 4083 intersects with and is insulated from end portions of a plurality of data connecting lines 404. The second sub repair line 4082 includes two ends respectively connected to left ends of the first and third sub repair lines 4081, 4083. The fourth sub repair line 4084 includes two ends respectively connected to right ends of the first and third sub repair lines 4081, 4083.

If two of the data connecting lines 404 are both broken and each have a broken gap, the broken data connecting lines 404 can be repaired by electrically connecting the third sub repair lines 4083 corresponding to the broken gaps to the broken lines 404, and cutting off the first and second sub repair lines 4081, 4082 from points located between the two broken data connecting lines 404. Therefore, the data signals provided by the data driver 420 can be sent to the corresponding data lines (not labeled), the broken data connecting lines 404 are repaired.

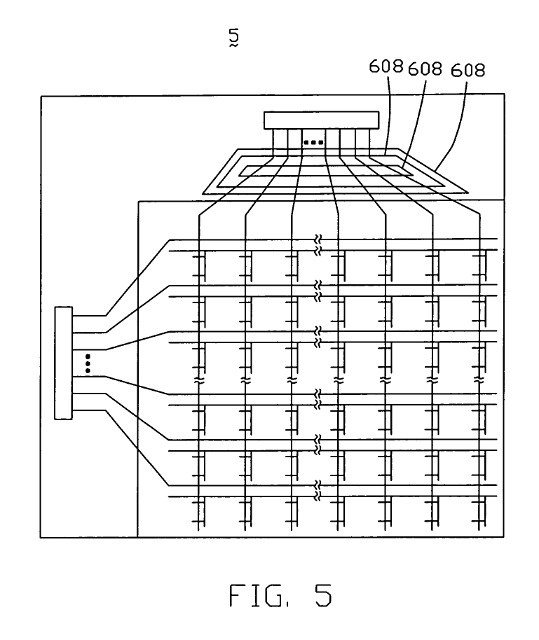

Referring to FIG. 5, an abbreviated circuitry diagram of a liquid crystal panel 5 according to a fourth embodiment of the present invention. The liquid crystal panel 5 is similar to the liquid crystal panel 4. However, the liquid crystal panel 5 includes a plurality of close-type repair lines 608 spreading outwardly sequentially. Each of the repair line 608 includes a first sub repair line (not labeled), a second sub repair line (not labeled), a third sub repair line (not labeled), and a fourth sub repair line (not labeled) connected end to end forming an enclosure. The first sub repair lines each intersect with and are insulated from a plurality of pads (not labeled) of a data driver (not labeled). The third sub repair lines each intersect with and are insulated from a plurality of data connecting lines (not labeled). The second sub repair lines each are connected between the first sub repair lines and the third sub repair lines respectively. The fourth sub repair lines each are connected between the first sub repair lines and the third sub repair lines respectively. The repair lines 608 are insulated from each other. In the illustrated embodiment, the repair lines 608 each can repair one of the data connecting lines in case the data connecting line has a broken gap. Therefore, when two or more data connecting lines have broken gaps, the broken data connecting lines can be repaired.

In alternative embodiment, the repair line 208 can also be arranged adjacent to the gate driver 220 and configured for repairing the gate connecting lines 204. The first sub repair line 2081 can also intersect with end portions of the data connecting lines 204 that are adjacent to the data driver 220. In another alternative embodiment, the repair line 208 further includes a plurality of fourth sub repair lines parallel to the third sub repair line, and each of the fourth sub repair lines connects the first and second sub repair and is insulated from each other.

It is to be understood, however, that even though numerous characteristics and advantages of the present embodiments have been set out in the foregoing description, together with details of the structures and functions of the embodiments, the disclosure is illustrative only, and changes may be made in detail, especially in matters of shape, size and arrangement of parts within the principles of the invention to the full extent indicated by the broad general meaning of the terms in which the appended claims are expressed.

What is claimed is:

1. A liquid crystal panel comprising:
a data driver comprising a plurality of first pads;
a gate driver comprising a plurality of second pads;
a plurality of data lines arranged in parallel and spaced from each other;
a plurality of gate lines arranged in parallel and spaced from each other, the gate lines intersecting with the data lines and being insulated from the data lines;
a plurality of data connecting lines, the first pads being connected to the data lines via the data connecting lines respectively;
a plurality of gate connecting lines, the second pads being connected to the gate lines via the gate connecting lines respectively; and
a repair line comprising a first sub repair line, a second sub repair line, and a third sub repair line, the first sub repair line intersecting with end portions of the data connecting lines that are adjacent to the data lines and being insulated from the data connecting lines, the second sub repair line intersecting with and being insulated from the first pads, the third sub repair line electrically connecting the first and second sub repair lines.

2. The liquid crystal panel in claim 1, wherein the repair line is provided adjacent to the data lines.

3. The liquid crystal panel in claim 1, wherein the repair line further comprises a plurality of fourth sub repair lines, each of the fourth sub repair lines connecting the first and second sub repair and being insulated from each other.

4. The liquid crystal panel in claim 1, further comprising a repair line configured for repairing the gate connecting lines.

5. The liquid crystal panel in claim 1, wherein the repair line further comprises a fourth sub repair line electrically connecting the first and second sub repair lines, the first, second, third, and fourth sub repair lines forming a close-type ring.

6. The liquid crystal panel in claim 1, further comprising a plurality of common electrodes parallel to the gate lines, a plurality of first portions extending perpendicularly from the common electrode and corresponding to the pixel areas, and two second portions extending perpendicularly from each first portion with a predetermined distance to each other to intersecting with the corresponding data line with one of the second portions adjacent to the common electrode and the other one of the second portions adjacent to the corresponding gate line.

7. A liquid crystal panel comprising:
a plurality of connecting lines configured for transmitting signals from a plurality of pads to a plurality of signal lines respectively; and
a repair line, the repair line comprising a first portion intersecting with the pads and being insulated from the pads, a second portion intersecting with the connecting lines adjacent to end portions of the connecting lines, and a third portion electrically connecting the first and the second portions; the repairing line being insulated from the connecting lines and configured for repairing the connecting lines when at least one of the connecting lines is broken by electrically connecting the first portion to the pads and second portion to the broken line.

8. The liquid crystal panel in claim 7, wherein the repair line is electrically connected to the connecting line by a process of welding.

9. The liquid crystal panel in claim 7, wherein the repair line comprises a first sub repair line, a second sub repair line, and a third sub repair line, the first sub repair line intersecting with and being insulated from the pads, the second sub repair line intersecting with and being insulated from the connecting lines from where adjacent to the signal lines, the third sub repair line electrically connecting the first and second sub repair lines.

10. The liquid crystal panel in claim 9, wherein the repair line further comprises a plurality of fourth sub repair lines parallel to the third sub repair line, each of the fourth sub repair lines connecting the first and second sub repair and being insulated from each other.

11. The liquid crystal panel in claim 9, wherein the repair line further comprises a fourth sub repair line electrically connecting the first and second sub repair lines, the first, second, third, and fourth sub repair lines forming a close-type line.

12. The liquid crystal panel in claim 9, further comprising a plurality repair lines which are insulated from each other, the first sub repair lines of the repair lines intersecting with and being insulated from the pads, the second sub repair lines intersecting with and being insulated from the connecting lines, the third sub repairs line electrically connecting the first and second sub repair lines.

13. The liquid crystal panel in claim 9, further comprising a plurality of common electrodes parallel to the gate lines, the data lines and the gate lines defining a plurality of pixel areas, the common electrodes each comprising a plurality of vertical portions corresponding to the pixel areas, and each vertical portion comprising two horizontal portions intersecting with the data line.
